(19) United States
(12) Patent Application Publication
(10) Pub. No.: US 2026/0264553 A1
(43) Pub. Date: Sep. 10, 2026

(54) METHOD AND SYSTEM FOR MANAGING AN ELECTRIC BATTERY DEVICE OF AN ELECTRIC OR HYBRID MOTOR VEHICLE

(71) Applicant: AMPERE S.A.S., Boulogne Billancourt (FR)

(72) Inventors: Philippe GYAN, Guyancourt Cedex (FR); Martin PEREZ-CHUECOS, Guyancourt Cedex (FR)

(73) Assignee: AMPERE S.A.S., Boulogne Billancourt (FR)

(21) Appl. No.: 18/723,521

(22) PCT Filed: Dec. 15, 2022
(86) PCT No.: PCT/EP2022/086047

§ 371 Date: Oct. 2, 2024

(30) Foreign Application Priority Data
Dec. 27, 2021 (FR) 2114541

(51) Int. Cl. B60L 53/62; H02J 7/80

(52) U.S. Cl. CPC B60L 53/62; H02J 7/80; B60L 2240/545

(57) ABSTRACT

A system and method manage a battery device to enable preventive limiting of a maximum authorized level of charge as a function of the context external to the vehicle in order to optimize the service life of the battery device

The invention relates to a method and system for managing an electric battery device. The invention also relates to an electric or hybrid motor vehicle equipped with said system and/or implementing said method.

Hybrid or electric motor vehicles are equipped with a battery device, also called a battery, electrical energy storage device or battery pack, capable of supplying electrical energy to at least one element of an electric power train of the vehicle. In particular, battery devices currently used in electric vehicles or hybrid vehicles are mainly based on lithium-ion technology. During use, the battery device is controlled and monitored by a dedicated management system, known as a battery management system or BMS, in order to monitor and control the state and the operation of the various modules and cells of which it consists. Such a system conventionally makes it possible to evaluate the state of charge, or SOC, of the device, along with its state of health, or SOH, in particular its ageing.

As is known, the ageing of the battery device is accelerated exponentially when it exhibits high temperatures, resulting from heating thereof due to it being used and/or due to outside ambient temperatures, in particular of the order of 45 or 50° C. Such ageing is accompanied by a loss of capacity of the battery device, along with an increase in its internal resistance. This results in a significant reduction in the service life of the battery device, which may add up to years. Although vehicles are conventionally equipped with heat treatment systems for cooling the battery device, said systems are only operational when the vehicle is in use, for example in the driving, discharging or charging phases, but not when the vehicle is stopped, in the stationary state.

It has also been found that, at a given temperature, the ageing of the battery device is liable to vary as a function of the state of charge. In particular, ageing is accelerated when the battery device is at a level of charge of 100%, corresponding to maximum charging of the charge capacity of the battery device, or close to 100%, in relation to a state of charge markedly lower than such a maximum capacity, thereby further reducing the service life of the device. The magnitude of such a reduction in service life is greater the more the temperature increases.

Since vehicles are liable to be in a stationary state most of the time, or even up to 90% or 95% of the time, it is essential to ensure that these periods in a stationary state are spent, as far as possible, under conditions that optimize the service life of the battery device, particularly when outside conditions, in particular the outside ambient temperature, are likely to affect the battery device.

Patent application DE 102019000813A1 describes a charging method that makes it possible, in order to avoid accelerated ageing of the battery, to continuously adjust the maximum state of charge as a function of temperature. However, this solution is sensitive to brief increases in temperature and often unduly limits the maximum state of charge, while only extended increases, for example heat waves, impact the ageing of the battery.

The invention falls within this context and aims to provide a method and a system for managing the battery device that rectify the abovementioned drawbacks. In particular, the invention aims to ensure refined management of the battery device during stationary phases between charging events.

According to the invention, a method makes it possible to manage an electric battery device for an electric or hybrid motor vehicle. The method comprises, in anticipation of charging of the battery device, a step of detecting an ambient temperature outside the vehicle using at least one sensor and a step of comparing the measured outside ambient temperature with a first predefined temperature threshold. The method furthermore comprises, when the measured temperature is greater than or equal to the first threshold:
a step of activating a phase of monitoring the outside temperature in order, via the at least one sensor, to measure the outside ambient temperature at a predetermined time interval and to record said measurement on a memory unit; and
a step of calculating a median or an average of the outside ambient temperature measurements carried out from a time t₀ of activation of the monitoring phase, and a step of comparing said median or said average with a second predefined temperature threshold and/or a third predefined temperature threshold, the third threshold being greater than the second threshold; and
a step of programming the limit of a maximum authorized level of charge of the battery device, via a control module, to an intermediate level of charge (N_{c_max_care}), lower than a maximum charge capacity of the battery device, implemented when the temperature median or average is greater than or equal to the third threshold;
a step of programming the limit of the maximum authorized level of charge of the device to a full level of charge, equal to the maximum charge capacity of the battery device, and a step of interrupting the monitoring phase, said steps being implemented when the temperature median or average is lower than the second threshold.

The method may comprise, following activation of the monitoring phase, a step of determining a time that has elapsed since the activation of the monitoring phase and a step of comparing the determined elapsed time with a predefined minimum activation time threshold, the step of programming the adapted limit being implemented only when the elapsed time is greater than or equal to the minimum activation time threshold.

The method may furthermore comprise a step of detecting a luminous intensity outside the vehicle and a step of comparing the measured luminous intensity with a predefined brightness threshold, the step of programming the adapted limit being implemented only when the measured luminous intensity level is greater than or equal to a predefined time threshold.

The method may furthermore comprise a step of measuring a temperature of the battery device and a step of comparing the measured temperature with a predefined threshold for detecting heating of the device, the step of programming the limit to an intermediate level of charge being implemented only when the measured temperature of the battery device is greater than or equal to the threshold for detecting heating of the battery device.

The method may furthermore comprise a step of adjusting the time interval at which the measurements of the outside ambient temperature are carried out as a function of at least one parameter external to the vehicle.

The method may comprise, prior to the step of programming the adapted limit, a step of detecting a need for mobility, programmed or provided by the user, the carrying out of the step of programming the limit to an intermediate level of charge being subject to a condition of said limit being accepted by a user of the vehicle.

According to the invention, a method makes it possible to charge a battery device and comprises, in a first stage, all of the steps of the management method defined above, and then a step of charging the battery device, during which the maximum authorized level of charge is limited to the previously defined full or intermediate level of charge.

The charging method may comprise a step of detecting charging of the vehicle and a step of interrupting the monitoring phase as soon as charging is implemented.

According to the invention, a system makes it possible to manage an electric battery device comprising hardware elements and/or software elements implementing the management method defined above, the hardware elements comprising at least one outside ambient temperature sensor, a processing unit able to receive measurements from the at least one sensor, a memory unit and a control module for controlling the battery device.

According to the invention, a hybrid or electric motor vehicle comprises at least an electric battery device and a management system defined above.

According to the invention, a computer program product comprises program code instructions recorded on a computer-readable medium for implementing the steps of one and/or the other of the methods defined above and/or for implementing the steps of the methods defined above when said program runs on a computer.

According to the invention, a computer program product able to be downloaded from a communication network and/or recorded on a computer-readable and/or computer-executable data medium is characterized in that it comprises instructions that, when the program is executed by the computer, cause said computer to implement one and/or the other of the defined methods.

The invention also relates to a computer-readable data recording medium on which there is recorded a computer program comprising program code instructions for implementing one and/or the other of the defined methods or a computer-readable recording medium comprising instructions that, when they are executed by a computer, cause said computer to implement one and/or the other of the defined methods.

The invention also relates to a signal of a data carrier, carrying the computer program product as defined above.

Other details, features and advantages will become more clearly apparent from reading the detailed description given below, by way of indication and without limitation, in relation to the various exemplary embodiments illustrated in the following figures:

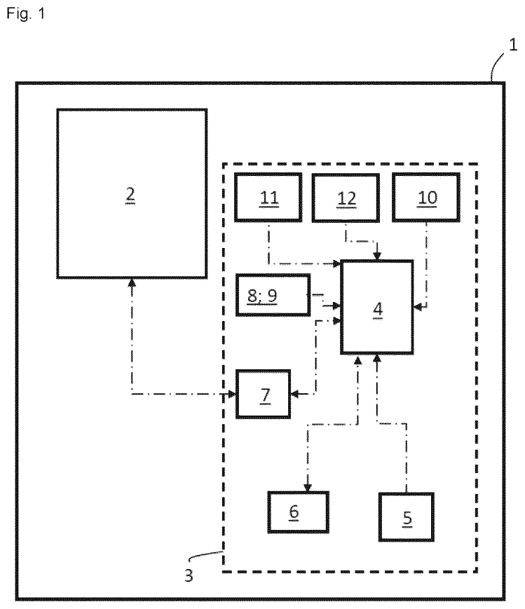

FIG. 1 schematically shows one embodiment of a vehicle equipped with a management system for managing a battery device.

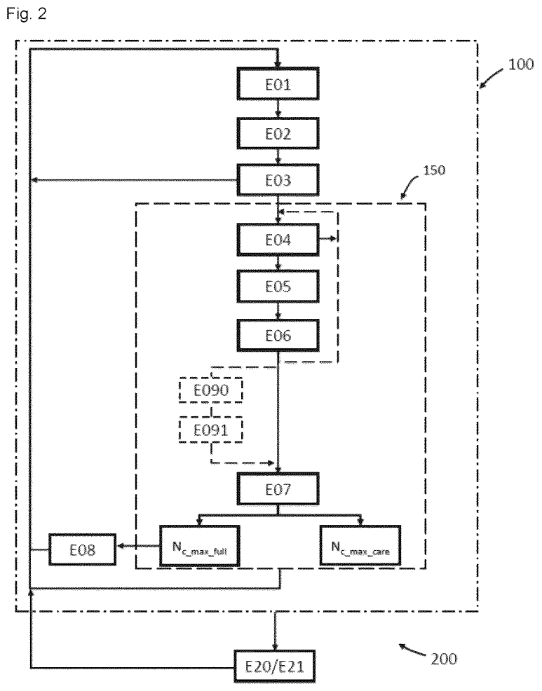

FIG. 2 is a flowchart of one exemplary execution of a method for managing the battery device.

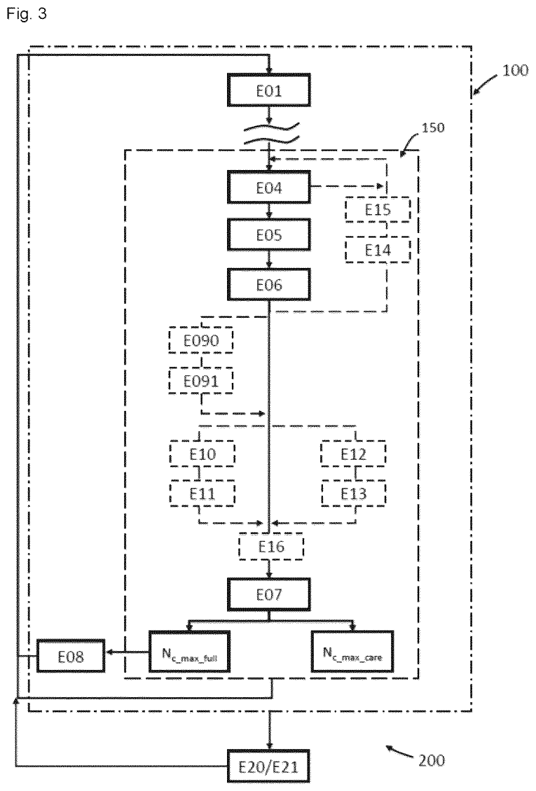

FIG. 3 is a flowchart of one particular exemplary execution of the method for the battery device illustrated in FIG. 2.

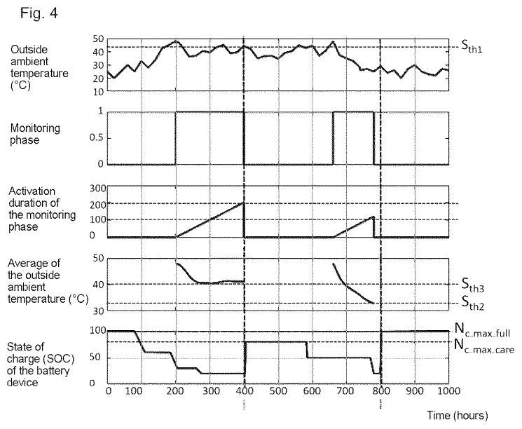

FIG. 4 is a set of graphs detailing one exemplary execution of the management method as a function of time.

FIG. 1 schematically illustrates one exemplary embodiment of an electric or hybrid motor vehicle 1 according to the invention. The vehicle 1 may be of any kind, that is to say it may be a private vehicle, a commercial vehicle, a truck or a bus. The vehicle may also be an autonomous or non-autonomous vehicle.

The vehicle 1 is equipped with an electric battery device 2, also referred to as a battery, electrical energy storage device or else battery pack, configured to supply electrical energy to one or more elements of an electric drive train of the vehicle 1, not shown. For example, it may supply power to an electric motor. The battery device 2 comprises a plurality of modules each comprising a plurality of electrochemical cells, in particular lithium-ion cells.

The vehicle 1 is furthermore equipped with a management system 3 for managing the battery device 2. The management system 3 comprises hardware elements and/or software elements implementing a management method as described below. The hardware elements comprise a processing unit 4 and one or more sensors 5 for measuring the ambient temperature outside the vehicle 1. The system may also comprise a memory unit 6 and a control module 7 for controlling the battery device 2.

The processing unit 4 comprises at least one computer comprising hardware resources and software resources, more specifically at least one processor, or microprocessor. The processing unit 4 cooperates with the memory unit 6 and is able to receive data transmitted by the one or more temperature sensors 5. The processing unit 4 is able to execute instructions in order to implement a computer program.

The control module 7 is configured to receive data and/or instructions from the processing unit 4. It is able to modify the operation of the battery device 2, in particular in order to modify a value of a maximum authorized level of charge N_{c_max} of said device as required, and in order to actuate the at least one temperature sensor 5 in order to trigger the measuring process. The control module 7 may, by way of non-limiting example, be an electronic controller of the vehicle.

Optionally, the management system 3 may also comprise at least one of the following:
at least one luminous intensity sensor 8 for sensing luminous intensity outside the vehicle 1;
at least one temperature sensor 9 for sensing the temperature of the battery device 2;
a localization means 10 for localizing the vehicle 1;
a communication means 11 for communicating with a connected device and/or a remote server;
a human-machine interface 12.

The management system 3 may for example comprise a single luminous intensity sensor 8, the measurements from which are transmitted to the processing unit 4. As an alternative, the management system 3 may comprise a plurality of said sensors 8 arranged at various points of the vehicle 1, and the various luminous intensity measurements may then be transmitted to the processing unit 4, which extracts the average therefrom.

Similarly, the management system may comprise at least one temperature sensor 9 for sensing the temperature of the battery device 2. In particular, such a sensor 9 may be contained in a BMS (battery management system) computer. The system may comprise a single sensor 9 measuring a temperature of the battery device 2 at one point or, as an alternative, a plurality of sensors 9 measuring the temperature of the various modules and/or cells of the battery device 2, which are then transmitted to the processing unit 4, which extracts, on the basis of said measurements, a temperature average representative of the temperature of the battery device 2, along with the maximum value and the minimum value of said temperatures. By way of example, and for more effective protection of the battery device 2, the maximum temperature may be selected to be transmitted to the processing unit 4.

The localization means 10 makes it possible to localize the vehicle 1 in the road infrastructure. It incorporates for example a localization system for providing an approximate location of the vehicle 1 and/or a high-definition map of the road infrastructure. In particular, the approximate location of the vehicle 1 may be provided by a GPS (global positioning system). As an alternative or in addition, the localization means 10 may be a localization system on board the vehicle 1, which incorporates the movements of the vehicle 1 at all times.

The communication means 11 allows the vehicle 1 to receive data from a connected device, such as a telephone, a watch or a calendar, by way of a low-frequency or high-frequency wireless link. This may for example be a wireless link based on cellular, Bluetooth or Wi-Fi technologies.

The human-machine interface 12 may comprise a screen capable of broadcasting, without limitation, information relating to the progress of the method or else to a state of the battery device 2.

FIGS. 2 and 3 illustrate one mode of execution of a method 100 for managing the battery device 2 in anticipation of charging of the battery device 2. In other words, said method is essentially carried out prior to carrying out charging of the battery device 2, in particular what is referred to as a normal charge, a fast charge, an ultra-fast charge, or even a regenerative charge resulting from regenerative braking during a driving phase. The method may be carried out during a stationary phase, in which the vehicle is at a standstill, or during a driving phase, ahead of a charging phase of the battery device. The method may also be likened to a method for operating or for using the management system 3 as described above.

Generally speaking, the management method 100 comprises, in anticipation of charging of the battery device 2, a step E01 of detecting an ambient temperature T_{amb} outside the vehicle 1 using the at least one temperature sensor 5. The detection step E01 may be initiated by the control module 7 periodically at a predefined spaced frequency, for example of the order of once to twice a day. The method is then in a phase comparable to standby, and few measurements are carried out. The control module 7 triggers at least one sensor 5 for sensing the outside ambient temperature. The measurement that is carried out is transmitted to the processing unit 4, which implements a step E02 of comparing the measured outside ambient temperature T_{amb} with a first predefined temperature threshold Sₜₕ₁, corresponding to a threshold for triggering monitoring. Preferably, the first temperature threshold Sₜₕ₁ may be between 35 and 50° C., for example of the order of 40 or 45° C.

If the measured outside ambient temperature T_{amb} is lower than the first threshold Sₜₕ₁, the method may be interrupted in advance, that is to say the management system continues to simply carry out a step E01 of detecting the outside ambient temperature T_{amb} periodically. Conversely, if the measured outside ambient temperature T_{amb} is greater than or equal to the first threshold Sₜₕ₁, that is to say the outside temperature reaches heating values likely to affect the battery device 2, the management system 3 implements a monitoring phase 150, in particular a phase of monitoring the outside ambient temperature, comprising all or some of the various steps explained below.

In particular, the control module 7 carries out a step E03 of activating the phase 150 of monitoring the outside ambient temperature T_{amb}. The monitoring phase 150 comprises a step E04 of repeatedly measuring the outside ambient temperature T_{amb} at a predetermined time interval I_{m_x}. These measurements are carried out periodically by way of the at least one temperature sensor 5, which is actuated by the control module 7. Said measurements are then recorded on the memory unit 6.

The time interval I_{m_x} may be a fixed time interval. The time interval I_{m_x} is in particular defined such that the measurements are carried out at a higher frequency than the measurement frequency in the detection step E02. By way of non-limiting example, the time interval I_{m_x} may be between 2 and 6 hours, for example of the order of 4 hours. According to one non-limiting exemplary execution, explained in more detail below and able to be seen in FIG. 3, the predefined time interval I_{m_x}may be made to vary over time, for example in order to vary over the course of a day or over the course of a week, in particular as a function of the context external to the vehicle 1. For example, the time interval may vary as a function of the time of day, as a function of a luminous intensity detected by way of at least one luminous intensity sensor 5, of the location of the vehicle 1, obtained by way of the localization means 10, and/or of weather conditions detected for example by way of a connected device.

Once a plurality of measurements of the outside ambient temperature have been taken, the processing unit 4 implements a step E05 of calculating a median or an average T_{m_amb} of the measurements of the outside ambient temperature T_{amb} carried out since a time t₀ of activation of the monitoring phase 150. The median or average T_{m_amb} thus obtained is then compared E06 with a second predefined temperature threshold Sₜₕ₂ and/or a third predefined temperature threshold Sₜₕ₃, the third threshold Sₜₕ₃ being greater than the second threshold Sₜₕ₂. The second threshold Sₜₕ₂ corresponds to a threshold for deactivating the monitoring phase, that is to say a threshold below which the outside ambient temperature is not likely to damage the battery device and for which the monitoring phase may be interrupted. Such a threshold may be lower than or equal to the first threshold Sₜₕ₁. For example, it may be between 30 and 40° C., in particular of the order of 30° C. Conversely, the third threshold Sₜₕ₃ corresponds to a temperature threshold for which it is known to observe a reduction in the service life of the battery device 2. The third threshold Sₜₕ₃ may be greater than or equal to the first threshold Sth1.

Advantageously, step E05 of calculating the median or average T_{m_amb} and comparison step E06 are repeated following each new measurement of the outside ambient temperature T_{amb} Implemented during the monitoring phase so as to update a previously calculated median or average T_{m_amb} and with the last outside ambient temperature measurement T_{amb} carried out.

Depending on the result of the comparison E06 carried out by the processing unit 4, either the management system 3 implements a step E07 of programming the limit of the maximum authorized level of charge N_{c_max} of the battery device 2 to an adapted level, as described below, or measurement step E04, step E05 of calculating the median or average and comparison step E06 are repeated periodically at the predefined time interval until a result that triggers a step E07 of programming the limit is obtained.

When the temperature median or average T_{m_amb} is greater than or equal to the third threshold Sₜₕ₃, that is to say a temperature liable to bring about an acceleration in the ageing of the battery device 2 is observed, step E07 of programming the limit is carried out so as to limit, via the control module 7, the maximum authorized level of charge N_{c_max} of the battery device 2 to an intermediate level of charge N_{c_max_care} lower than a maximum charge capacity of the battery device 2. In this way, at least one future charge of the battery device 2, carried out immediately after the implementation of the management method 100 according to the invention, will be constrained to such a limit, and the charging will be able to be carried out only up to the defined intermediate level of charge N_{c_max_care}, and not up to the maximum charge capacity of the battery device 2. It goes without saying that such a principle is valid only on the condition that, at the time when the method according to the invention is carried out and at the time when charging is implemented, the state of charge, or SOC, of the battery device is lower than the intermediate level of charge N_{c_max_care}.

By way of non-limiting example, such an intermediate level of charge N_{c_max_care} may be between 75 and 95% of the maximum charge capacity of the battery device 2. In particular, the intermediate level of charge N_{c_max_care} may be of the order of 80% of the maximum charge capacity of the battery device 2.

The intermediate level of charge N_{c_max_care} may also be defined at a fixed, preprogrammed value or, as an alternative, may be variable. For example, the value of the intermediate level of charge N_{c_max_care} may be selected, depending on the calculated temperature median or average, from a plurality of intermediate values lower than the maximum charge capacity of the battery device. Such a selection may be made on the basis of a 2D map defined as a function of temperature. As an alternative, the value of the intermediate level of charge N_{c_max_care} may be calculated on the basis of the value of the intermediate level of charge N_{c_max_care} and a service life objective.

When the obtained temperature median or average T_{m_amb} is lower than the second threshold Sₜₕ₂, that is to say it is detected that the outside ambient temperature is not likely to affect the service life of the battery device 2, step E07 of programming the limit of the maximum authorized level of charge of the device is carried out so as, for at least one future charge, to set the maximum authorized level of charge N_{c_max} to a full level of charge N_{c_max_full}, equal to the maximum charge capacity of the battery device 2. In other words, there is then no limit on the charge capacity. In addition, the management system 3 orders the interruption E08 of the monitoring phase 150. The management system 3 may then initiate a new cycle of carrying out the method according to the invention and enter a standby phase during which the outside ambient temperature is measured periodically, as explained with reference to step E01, pending the triggering of a new monitoring phase 150.

Such a method thus advantageously enables preventive automated triggering of the limiting of the maximum authorized level of charge to an adapted value as a function of the outside ambient temperature. The method is furthermore advantageously configured so as to prevent unexpected triggering, resulting from an isolated temperature measurement that may be incorrect, for example due to the immediate external environment of the vehicle 1.

According to one particular optional embodiment, the method according to the invention may comprise, following the activation E03 of the monitoring phase 150 at the time t₀, a step E090 of determining a time t_{act} that has elapsed since said activation and a step E091 of comparing the determined elapsed time t_{act} with a predefined minimum activation time threshold S_{act_min}. Step E07 of programming the adapted limit, as explained above, may then be implemented only when the determined elapsed time t_{act}, relative to the time t₀, is greater than or equal to the minimum activation time threshold S_{act_min}. According to one non-limiting example, such a minimum threshold may be defined so as to ensure that at least three measurements of the outside ambient temperature are taken. For example, for repeated measurements carried out at an interval I_{m_x} of 4 hours, the minimum activation time threshold may be 10 hours, such that step E07 of programming the limit of the maximum level of charge N_{c_max}is implemented only after three measurements of the outside ambient temperature have been taken. In particular, measurements may be carried out when the elapsed time is 10 hours, 14 hours and 18 hours.

FIG. 3 illustrates alternative modes of execution of the management method 100 according to the invention comprising, in addition, confirming a detected outside situation, via the outside ambient temperature measurements, by way of at least one other parameter also representative of said situation.

According to a first exemplary execution, the method may comprise confirming the detected situation by analyzing the luminous intensity Lₑₓₜ outside the vehicle 1. In this sense, the management method 100 comprises a step E10 of detecting a luminous intensity Lₑₓₜ outside the vehicle 1 and a step E11 of comparing the measured luminous intensity Lext with at least one predefined brightness threshold S_{L_ext}.

Such a principle is intended to confirm that the measurements of the Outside ambient temperature T_{amb} that are carried out are not biased, for example due to an element in the immediate environment of the vehicle 1 or the way in which the vehicle is used. In particular, when the method according to the invention is carried out during a driving phase, the impact of wind on the vehicle is liable to affect the measurement of the ambient temperature.

The carrying out of step E07 of programming the adapted limit may thus be subordinated to the result of such a measurement of the luminous intensity Lₑₓₜ. In particular, it may be implemented only when the measured luminous intensity level Lₑₓₜ is greater than or equal to the at least one predefined luminous intensity threshold. For example, such a threshold may be of the order of 50000 lux or 100000 lux, corresponding to a level of solar irradiation liable to bring about heating of the battery device 2.

As an alternative, one or more luminous intensity thresholds S_{L_ext} may be defined so as to distinguish, or categorize, whether the measurement is carried out during the day or at night and/or so as to at least partially evaluate the weather conditions, for example sunny or overcast weather, and/or an immediate environment of the vehicle 1, for example illuminated or shaded. The carrying out of step E07 of programming the adapted limit may then be subordinated to the result of such a categorization of the measurement of the luminous intensity Lₑₓₜ.

A similar principle applies, mutatis mutandis, to the evaluation of the temperature of the battery device 2. The method may thus comprise, as an alternative or in addition to the steps relating to the measurement of the luminous intensity Lₑₓₜ described above, confirming the detected situation based on the evaluation of the temperature T_{batt} of the battery device 2. The method then comprises a step E12 of measuring a temperature T_{batt} of the battery device 2 and a step E13 of comparing the measured temperature T_{batt} with a predefined threshold S_{T_batt} for detecting heating of the device. The temperature T_{batt} of the battery device 2 may be measured at one point, for example at least of a single sensor 9 contained in the BMS computer of the battery device 2 or, as an alternative, may be obtained by calculating a median or average of measured temperatures of the various cells and/or module of the battery device 2, which are then obtained by a plurality of sensors.

As above, the carrying out of step E07 of programming the adapted limit may then be subordinated to the temperature of the battery device 2. For example, the limit of the maximum authorized level of charge N_{c_max} is limited to an intermediate value N_{c_max_care} only when the measured temperature T_{batt} of the battery device 2 is greater than or equal to the threshold S_{T_batt} for detecting heating of the battery device 2. By way of non-limiting example, the threshold for detecting heating of the battery device 2 may be between 40 and 50° C., for example of the order of 45° C.

As illustrated, the method may thus optionally comprise one and/or the other of said confirmation steps. According to various alternatives, the measurements of luminous intensity Lₑₓₜ and/or of the temperature T_{batt} of the battery device 2 may be carried out at the same time as the repeated measurements E04 of the external ambient temperature T_{batt}, or subsequently for example during the calculation of the outside ambient temperature median or average T_{m_amb} or following the comparison of said median or average T_{m_amb} with the second and third temperature threshold Sₜₕ₂, Sₜₕ₃.

According to one alternative that is not shown, the abovementioned confirmation steps may be carried out only when the result of the comparison step E06 is likely to lead to the carrying out of a step E07 of programming the limit of the maximum authorized level of charge N_{c_max}.

In addition, as briefly explained above, the luminous intensity measurements that are carried out may optionally be used to adjust the time interval I_{m_x} at which the measurements of the outside ambient temperature are performed, as needed.

Indeed, as explained above, the predefined time interval I_{m_x} may be variable, said predefined time interval being able to be adjusted, by way of non-limiting example, as a function of parameters such as time of day, luminous intensity Lₑₓₜ, location and/or weather conditions. The method according to the invention may then comprise a step E14 of measuring and/or detecting such a parameter and a step E15 of adjusting the time interval I_{m_x} as a function of the at least one parameter under consideration. In particular, said steps may be carried out at the same time as the measurement of the outside ambient temperature. Said steps may also be repeated, in a manner similar to what has been explained above with reference to the measurements of external luminous intensity or the temperature of the battery device.

According to some particular examples, the time interval I_{m_x} may be variable depending on whether it is daytime or night-time, for example as a function of the time of day and/or of the measured luminous intensity Lₑₓₜ, the time interval being smaller during the day than at night. The same applies for the period of the year, the time interval I_{m_x} being smaller in the summer season than in the winter season. Similarly, if weather conditions liable to bring about heating of the battery device 2, even at a standstill, are detected by way of weather forecasts provided by a connected device or an on-board system in the vehicle, the time interval I_{m_x} may be reduced and the measuring frequency may thus be increased. Also, when the vehicle 1 is located in a geographical region having climatic conditions liable to bring about heating of the battery device 2, for example detected by the localization means, the measuring frequency may be increased.

FIGS. 2 and 3 also illustrate, in dotted lines, an example of an optional mode of execution of the method according to the invention in which the programming E07 of the limit of the maximum authorized level of charge N_{c_max} depends on the agreement of the user, in particular in order not to impact their mobility. In this sense, the method may comprise, when it is determined that the level of charge should be set to the intermediate level N_{c_max_care} and prior to programming E07 said limit, a step E16 of detecting a need for mobility, programmed or provided by the user. The need for mobility may be determined on the basis of a destination provided by the user via the localization means 10 and/or via a connected device. The processing unit 4, or any other computer on board the vehicle 1, may then estimate a range required to make a journey to the provided destination and define whether or not the intermediate level of charge N_{c_max_care} allows the desired journey to be made without needing to recharge the battery device 2. If the limit of the level of charge to the intermediate level impacts the mobility of the vehicle 1 in a different way than what might be observed with the full level of charge N_{c_max_full}, then the management system 3, via the human-machine interface 12, may inform the user that the programming of the limit of the charge to an intermediate level planned for the next charge will impact their mobility. The system may for example inform the user of this at the time when the vehicle is started or at the time when charging is triggered. The carrying out of step E07 of limiting to an intermediate level of charge may then be subject to a condition of said limit being accepted by the user of the vehicle 1.

The invention furthermore relates to a method 200 for charging the battery device 2. Said method comprises, in a first stage, the steps of the management method 100 described above, said steps being carried out in anticipation of charging of the vehicle 1. In other words, said steps are essentially carried out before a charge, or between two charges. Once the limit has been programmed E07, when a step E20 of charging the battery device 2 is carried out, the maximum authorized level of charge N_{c_max} is limited to the previously defined full or intermediate level. The control module 7 ensures that charging is able to be carried out only up to the adapted maximum level of charge. It goes without saying that such a limit may be implemented only upon the condition that the level of charge of the battery device 2, at the time when the management method 100 is carried out and prior to the charging, is lower than the intermediate maximum level of charge.

Optionally, the charging method 200 may also comprise a step E21 of detecting charging of the vehicle 1. The fact that the vehicle 1 is being charged may be detected by way of the BMS computer and/or by way of the processing unit 4 and/or by detecting the connection of a charging port with which the vehicle 1 is equipped to a charging station. The monitoring phase 150 may then be interrupted as soon as charging E20 is initiated, that is to say as soon as charging is detected. A new cycle of carrying out the management method according to the invention may then be triggered.

According to one alternative embodiment that is not shown, the monitoring phase 150 may be maintained following the charging step and interrupted, as explained above, only when the calculated temperature median or average T_{m_amb} is lower than the second temperature threshold Sₜₕ₂.

FIG. 4 illustrates one example of the sequence of the charging method 200 according to the invention. Over the entire duration of the illustrated timing diagram, the vehicle 1 is considered to be parked at a standstill. After 200 hours, when the control module 7 is woken up, then a temperature check measurement is carried out. An outside temperature greater than the first threshold Sₜₕ₁ is detected. The control module 7 triggers the phase 150 of monitoring the outside ambient temperature in order to calculate the temperature median or average T_{m_amb} for temperatures measured during periodic wake-up events programmed at predefined time intervals I_{m_s}.

After 370 hours, the monitoring phase 150 has been activated for a time tact greater than the predefined activation time threshold S_{act_min}, for example set to 100 hours, and the outside ambient temperature median or average T_{m_amb} is greater than the third temperature threshold Sₜₕ₃. The control module 7 activates the limit of the maximum authorized level of charge to the intermediate level, here to 80% of the maximum charge capacity, for the next charge of the battery device 2 in order to ensure the service life thereof.

After 400 hours, the user recharges the battery device 2. The charging of the battery stops automatically at the intermediate maximum authorized level. The monitoring phase 150 is interrupted. After 660 hours, when the control module 7 is woken up, an outside ambient temperature greater than the first threshold Sₜₕ₁ is detected again. Following this detection E01, the electronic control module 7 activates the phase 150 of monitoring the outside temperature again in order to calculate the median or average T_{m_amb} of the measurements of the outside ambient temperature based on the measurements carried out since the start of this new monitoring phase 150.

After 780 hours, the monitoring phase 150 has been activated for a duration of 120 hours, greater than the predefined activation time threshold S_{act_min} of 100 hours. If the median or average T_{m_amb} of the outside ambient temperature is lower than the second temperature threshold Sₜₕ₂, the electronic control module programs the maximum charge limit in order to allow full charging of the battery device during the following charge and interrupts the phase 150 of monitoring the median or average outside temperature T_{m_amb}. A new monitoring phase will be triggered only if an outside temperature greater than the first threshold Sₜₕ₁ is detected during the standby phase.

After 800 hours, the user charges the battery device 2 of their vehicle 1. The battery device 2 may be charged to its maximum capacity level since the detected outside ambient temperatures are not likely to damage the battery device 2 and the maximum authorized level of charge has not had to be updated again.

The method and the system according to the invention thus advantageously allow preventive management of the battery device as a function of the context external to the vehicle, with a view to charging it. This results in an optimization of service life, but also of the utilization of the performance of the treatment device.

However, the present invention is not intended to be limited to the means and modes described and illustrated here, and also extends to any equivalent means or modes and to any technically operative combination of such means, provided that they achieve in fine the functionalities described and illustrated in this document

1-10. (canceled)

11. A method for managing an electric battery device for an electric or hybrid motor vehicle, the method comprising:
detecting, in anticipation of charging of the battery device, an ambient temperature outside the vehicle using at least one sensor; and
comparing the measured outside ambient temperature with a first predefined temperature threshold;
the method further comprising, when the measured temperature is greater than or equal to the first threshold:
activating a phase of monitoring the outside temperature in order, via the at least one sensor, to measure the outside ambient temperature at a predetermined time interval and to record said measurement on a memory unit;
calculating a median or an average of the outside ambient temperature measurements carried out from a time t₀ of activation of the monitoring phase;
comparing said median or said average with a second predefined temperature threshold and/or a third predefined temperature threshold, the third threshold being greater than the second threshold;
programming, when the temperature median or average is greater than or equal to the third threshold, the limit of a maximum authorized level of charge of the battery device, via a control module, to an intermediate level of charge, lower than a maximum charge capacity of the battery device; and
programming, when the temperature median or average is lower than the second threshold, the limit of the maximum authorized level of charge of the device to a full level of charge, equal to the maximum charge capacity of the battery device, and interrupting the monitoring phase.

12. The management method as claimed in claim 11, further comprising, following activation of the monitoring phase, determining a time that has elapsed since the activation of the monitoring phase and comparing the determined elapsed time with a predefined minimum activation time threshold, the programming the adapted limit being implemented only when the elapsed time is greater than or equal to the minimum activation time threshold.

13. The management method as claimed in claim 11, further comprising detecting a luminous intensity outside the vehicle and comparing the measured luminous intensity with a predefined brightness threshold, the programming the adapted limit being implemented only when the measured luminous intensity level is greater than or equal to a predefined time threshold.

14. The management method as claimed in claim 11, further comprising measuring a temperature of the battery device and comparing the measured temperature with a predefined threshold for detecting heating of the device, the programming the limit to an intermediate level of charge being implemented only when the measured temperature of the battery device is greater than or equal to the threshold for detecting heating of the battery device.

15. The management method as claimed in claim 11, further comprising adjusting the time interval at which the measurements of the outside ambient temperature are carried out as a function of at least one parameter external to the vehicle.

16. The management method as claimed in claim 11, further comprising, prior to the programming the adapted limit, detecting a need for mobility, programmed or provided by the user, the carrying out of the programming the limit to an intermediate level of charge being subject to a condition of said limit being accepted by a user of the vehicle.

17. A method for charging a battery device, comprising:
in a first stage, the management method as claimed in claim 11, and then charging the battery device, during which the maximum authorized level of charge is limited to the previously defined full or intermediate level of charge.

18. The charging method as claimed in claim 17, further comprising detecting charging of the vehicle and interrupting the monitoring phase as soon as charging is implemented.

19. A system for managing an electric battery device, comprising:
hardware elements and/or software elements configured to implement the management method as claimed in claim 11, the hardware elements comprising at least one outside ambient temperature sensor, a processor configured to receive measurements from the at least one sensor, a memory; and a control module configured to control the battery device.

20. A hybrid or electric motor vehicle, comprising:
an electric battery device; and
the management system as claimed in claim 19.
